(19) United States
(12) Patent Application Publication
(10) Pub. No.: US 2013/0317792 A1
(43) Pub. Date: Nov. 28, 2013

(54) SYSTEMS AND METHODS FOR MODELING STABILITY OF DAMAGED COLUMNS

(71) Applicant: Georgia Tech Research Corporation, Atlanta, GA (US)

(72) Inventor: Akash Dixit, Atlanta, GA (US)

(73) Assignee: Georgia Tech Research Corporation, Atlanta, GA (US)

(21) Appl. No.: 13/875,197

(22) Filed: May 1, 2013

Related U.S. Application Data
(60) Provisional application No. 61/640,982, filed on May 1, 2012.

(51) Int. Cl. G06F 17/50

(52) U.S. Cl. CPC G06F 17/5018
USPC 703/2

(57) ABSTRACT

The disclosed technology includes systems, methods, and computer program products for modeling the stability characteristics of elements with discontinuities. In an example embodiment, the element is a physical structure and the discontinuities are damage to the structure. In another example embodiment, the stability characteristics include buckling loads and buckling modes of a column.

### CROSS-REFERENCE TO RELATED APPLICATIONS

This application claims priority and the benefit under 35 U.S.C. §119(e) of U.S. Provisional Patent Application No. 61/640,982, filed 1 May 2012, of which the entire contents and substance are hereby incorporated by reference as if fully set forth below.

### BACKGROUND

1. Field of the Disclosed Technology

The disclosed technology evolves from research in the area of Structural Health Monitoring (SHM), and has application to the structural stability of discontinuous structures. More specifically, the disclosed technology relates to systems and methods of ascertaining the effect of damage on the stability of columns.

2. Description of Related Art

Structural Health Monitoring (SHM), which relates to discovering damage in structures (damage diagnosis) and predicting remaining life of structures (prognosis), is a rapidly expanding field both in academia and in industry. Much of the literature in the field of vibration-based SHM describes experiments for doing damage diagnosis. In some techniques, the changes to natural frequencies and mode shapes due to damage are ascertained to determine the location of the damage. Usually, displacement modes, curvature modes, or strain energy modes are used with these conventional techniques.

Mathematical models have been developed to provide an analysis for representing structural damage. Such mathematical models allow for prediction of structural response while explaining experimental readings by engaging the underlying physics. Conventional mathematical models make approximations based on the expected physical behavior due to damage in order to obtain the governing differential equations. However, these approximations related to the expected physical behavior are in addition to other approximations or assumptions already made in formulating the appropriate structural dynamics theory. Thus, even when exact solutions are obtainable, they are still merely solutions for an imperfect model. For example, the Ostachowicz model suffers from this approximation bias, and many other representative disadvantages and limitations.

The Ostachowicz model describes the expected physical behavior of a crack in a beam by modeling the crack as an elastic spring. The stiffness and flexibility of the spring are calculated based on concepts of fracture mechanics. As a result, for the solution, the beam is divided into as many elements as the number of the areas of damage, each with its own governing differential equation. The boundary conditions are given by the continuity of displacement, moment, and shear. The last boundary condition is given by the discontinuity of slope due to local flexibility of the elastic spring. Upon solving the governing differential equations, as many different displacement profiles are obtained as there are segments (which is one more than the number of cracks). Some of the numerous disadvantages of the Ostachowicz model include:
The model represents an exact solution to an approximate model based on expected physical behavior of the crack behaving as an elastic spring.
The size of the problem increases dramatically: If there are n points of discontinuity along the beam, the total number of simultaneous equations to be solved is 4(n+1) in terms of 4(n+1) unknowns. In such a case, the difficulty in calculation increases dramatically and in general can be very complex even for n=2.
The model does not apply to other types of common types of damage, such as a rectangular notch.
The framework to extend the model to two and three dimensional elements such as plates and shells is not given.
The inertia effects of the crack are not taken into account.
The procedure to determine the elastic properties of the hinge is empirical.
The physical fact that the status of the crack “breathes” (changes from open to closed) during vibrations is not considered.
The neutral axis change due to the presence of the damage is not addressed.
   The Ostachowicz model serves as an example for many other similar models sharing many of the above shortcomings.

Damaged columns, often referred in technical literature as “weakened” columns, conventionally have been modeled in a similar way to the structural dynamics approach above. For example, in a recent work by Zapata-Medina et al., damaged columns with arbitrary end conditions are modeled by placing a fictitious and arbitrary rotational-spring whose elastic properties are obtained by using the principles of fracture mechanics. Accordingly, this approach for modeling damaged columns suffers from similar shortcomings to the Ostachowicz model described above. Another conventional approach for modeling weakened columns by Caddemi et al. models a crack as delta functions. The solution to the resulting differential equations is again a burdensome proposition, as deliberated elaborately in the paper.

### SUMMARY

Some or all of the above limitations may be addressed by certain embodiments of the disclosed technology. Certain embodiments include systems, methods, and computer program products comprising computer-readable instructions for modeling an element with a discontinuity to obtain stability characteristics of the element with the discontinuity. Characteristics of the element without the discontinuity may be known, including one or more stability characteristics of the element without the discontinuity. The unified framework is used to provide the stability characteristics of the element with the discontinuity, and that information can be used in a number of other applications.

The method, system and computer program product comprise perturbing the one or more stability characteristics of the element without the discontinuity based on characteristics of the discontinuity, formulating nth-order, perturbed differential equations governing one or more stability characteristics of the element with the discontinuity, wherein n is 1 or greater, and solving, at least to order 1, the perturbed differential equations to obtain one or more stability characteristics of the element with the discontinuity.

The element can be a physical structure, for example, a column. The discontinuity can be damage, for example one or more cracks or notches. The stability characteristics can comprise one or more of buckling loads and buckling mode shapes.

Other embodiments, features, and aspects of the disclosed technology are described in detail herein and are considered a part of the claimed disclosed technology. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is an illustrative diagram of a notched column 100 representative of a structure with discontinuity, according to an example embodiment.

FIG. 2 is a flow diagram of the method 200, according to an example embodiment.

FIG. 3 depicts a block diagram of an illustrative computing device architecture 300, according to an example embodiment.

### DETAILED DESCRIPTION

To facilitate an understanding of the principles and features of the various embodiments of the disclosed technology, various illustrative embodiments are explained below. Although preferred embodiments of the disclosed technology are explained in detail, it is to be understood that other embodiments are contemplated. Accordingly, it is not intended that the disclosed technology is limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The elements described as making up the various embodiments of the disclosed technology are intended to be illustrative and not restrictive. Many suitable elements that would perform the same or a similar function as the elements described herein are intended to be embraced within the scope of the disclosed technology. Such other elements not described herein can include, but are not limited to, for example, elements that are developed after the time of the development of the disclosed technology such as new or additional damage profile functions or structures.

### ON STATIC STABILITY OF DAMAGED COLUMNS

E Young's modulus
P Mass density
μ Mode Shape (displacement, sectional rotation, bending strain or shear strain)
ud Undamaged (subscript)
d Damaged (subscript)
[symbol] Numerical factor for main mode shape
ξ Numerical factor for secondary mode shapes
x Space representation (1-D for beams, 2-D for plates and shells)
L_{b} Length of beam
h Depth of beam
H Heaviside function
∈ Ratio of depth of damage to total depth
Δl Width of damage
L Stiffness operator
M Mass operator

Φ Eigenfunction
I Area moment of inertia
A Area of cross-section
λ Eigen values
ω Natural frequency
z Subscript for non-dimensionalized quantity
Eₘ Mass defect
Eₛ Stiffness defect

The general eigenvalue problem to determine the modes and natural frequencies of elastic structures, such as rods, beams, plates and shells, is:

Lφ(xᵢ)−λMφ(xᵢ)=0 (1)

where L is the stiffness operator, M is the inertia matrix and λ is the eigenvalue. The order of L is an even integer, 2p. Equation 1 is valid at least for conservative distributed parameter structures, which represent a very large and important class of systems, namely self-adjoint systems. Note that λ=ω² where φ is the natural frequency, and φ is the eigenfunction or the mode shape. The independent variables xᵢ (i=1, 2, 3) denote the spatial dimensions (with i representing the direction). Therefore, it denotes the one-dimensional space in case of beams, the two-dimensional space in case of plates and shells, and the three-dimensional space in case of three-dimensional structures. The displacements and rotations corresponding to the spatial dimension xᵢ are μᵢ and θᵢ, respectively. Equation 1 has been solved for many cases of undamaged structures using various structural-dynamics theories.

A “unified framework” for modeling damage in structures to determine their natural frequencies and modes shapes was developed by Dixit and Hodges. According to this theory, the geometric discontinuity due to damage is represented in terms of the discontinuities in cross-sectional properties, such as depth, area, or area moment of inertia. The modeling of damage as such a discontinuity affects both the stiffness and the inertia term in the governing differential equation. The unified framework then perturbs the modes and the natural frequencies. The two steps of, (1) modeling the damage as a geometric discontinuity, and (2) the perturbation of modes and natural frequencies, results in the initial homogenous differential equation with non-constant coefficients being changed to a series of non-homogeneous differential equations with constant coefficients. This series of differential equations is then solved using modal superposition method to obtain natural frequencies and mode shapes of the damaged structure.

The unified framework addresses the limitations of conventional models in the field of SHM. The framework is applicable to damaged systems for arbitrary boundary conditions, and applies to structures with any damage profile and having more than one area of damage. The framework considers the geometric discontinuity at the damage location, but makes no ad hoc assumptions regarding the physical behavior at the damage location such as added springs or changes in Young's modulus.

Essentially, the unified framework, as described above, is a solution to an eigenvalue problem in which two differential operators with non-constant coefficients are involved. Previously, the unified framework has been used to determine the natural frequencies and mode shapes of damaged structural-dynamics-systems. However, certain embodiments of the disclosed technology can leverage the unified framework to determine stability characteristics of elements with discontinuities, such damage or notches in physical structures including columns.

### Application of Unified Framework to Buckling of Columns

According to certain embodiments, the buckling of columns can be described in a similar fashion to the natural frequencies of elastic structures, as expressed in Equation 1:

Lφ(xᵢ)−λPφ(xᵢ)=0 (2)

The structure of Equations 1 and 2 is similar except that in Equation 2, the inertia term M is substituted by the load term P. Also, λ now represents the buckling load and φ(xᵢ) represents the buckling mode. Moreover, in some embodiments, a similar solution procedure can be applied to the two sets of problems represented by Equations 1 and 2. For example, in the expressions of natural frequencies and mode shapes of damaged beams that are obtained using the unified framework, the inertia terms can be replaced with the axial load terms to obtain the expressions of buckling load and buckling modes respectively.

According to certain embodiments, in the case of Euler columns, the variables of Equation 1 are given by:

$$L = \frac{{d}^{2} {H}_{33} ( {x}_{1} )}{d {x}_{1}^{2}} \frac{{d}^{2}}{d {x}_{1}^{2}} \\ M = P \frac{{d}^{2}}{d {x}_{1}^{2}} \\ φ ( {x}_{1} ) = {u}_{1} ( {x}_{1} ) \\ {H}_{33} ( {x}_{1} ) = E ( {x}_{1} ) {I}_{3} ( {x}_{1} ) \qquad ( 3 )$$

where E and I are the Young's modulus and area moment of inertia respectively, and P is the axial load. All of these quantities are functions of space dimension x₁.

The boundary conditions for Equation 1 are given by:

Bᵢφ(xᵢ)=0 i=1, 2, . . . , p (4)

where Bᵢ is a differential operator of maximum order of 2p−1. Examples of clamped, pinned and free boundary conditions for Euler-columns are given by:

$${B}_{i} = \{ \begin{matrix}1 \\ \frac{d}{d {x}_{1}}\end{matrix} \} \\ @ {x}_{1} = clamped \\ {B}_{i} = EI \{ \begin{matrix}1 \\ \frac{{d}^{2}}{d {x}_{1}^{2}}\end{matrix} \} \\ @ {x}_{1} = pinned \\ {B}_{i} = EI \{ \begin{matrix}\frac{{d}^{2}}{d {x}_{1}^{2}} \\ \frac{{d}^{3}}{d {x}_{1}^{2}}\end{matrix} \} \\ @ {x}_{1} = free \qquad ( 5 )$$

### Damage Model

According to certain embodiments, the damage model presented models the change in cross-sectional thickness at the damage location. If the damage depth is h_{d} (xᵢ) then at the damage location the depth becomes h−h_{d} (xᵢ), where h is the constant depth at the undamaged location. Further a quantity h_{d} is defined which gives the average depth of the damage given by

$${\overline{h}}_{d} = {\int }_{Ω} {h}_{d} ( {x}_{i} ) d {x}_{i} \qquad ( 6 )$$

where Ω gives the domain of damage. Therefore, the depth of the structure is given by:

$$h ( {x}_{i} ) = h - {\overline{h}}_{d} γ ( {x}_{i} ) = h [ 1 - εγ ( {x}_{i} ) ] \\ ε = \frac{{h}_{d}}{h} \qquad ( 7 )$$

where γ(xᵢ) is the damage profile function and c gives ratio of the depth of damage to the depth at the undamaged location.

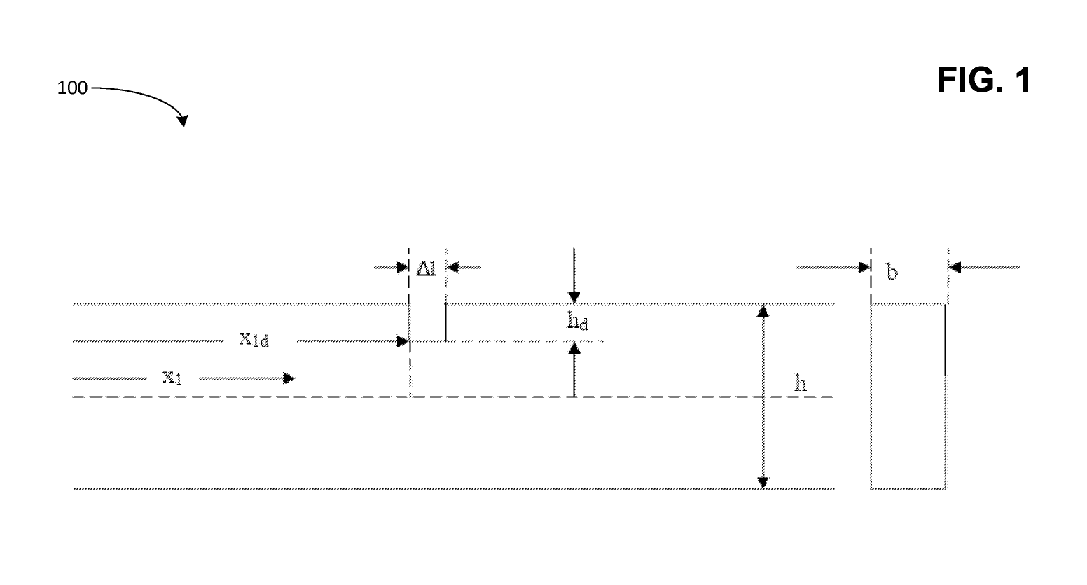

For example, consider a column of uniform rectangular cross section of width b and depth h as shown in FIG. 1. A rectangular through-thickness notch shaped damage is located at x=x_{d} with a width of Δl and depth of h_{d}. Notice in this case, h̅_{d}=h_{d}. The damage profile function can be given by:

h(x₁)=h− h̅_{d}[H(x₁−x_{1d})−H(x₁−x_{1d}−Δl)]=h[1−εγ(x₁)] (8)

γ(x₁)=H(x₁−x_{1d})−H(x₁−x_{1d}−Δl)

Here, H(x−x₁) denotes the Heaviside function.

According to various embodiments, other representations of the crack profile functions of columns for different types of damage can be given by:

For a V-shaped notch:

γ(x₁)=(x₁−x_{1d})−2(x₁−x_{1d}−Δl/2)+(x₁−x_{1d}−Δl) (9)

where ( ) denotes ramp function.

For a half V notch:

γ(x₁)=(x₁−x_{1d})−H(x₁−x_{1d}−Δl)+(x₁−x_{1d}−Δl) (10)

For saw-cut damage, the definition of differentiation can be used:

γ(x₁)=H(x₁−x_{1d})−H(x₁−x_{1d}−Δl)=Δlδ(x₁−x_{1d}) (11)

Other forms of discontinuity and their respective geometric definitions are contemplated and within the scope of this disclosure. Moreover, damage does not always occur in shapes giving regular profiles. In an example embodiment, where damage cannot be represented as a regular profile as listed above, a convolution integral can be used to obtain the expressions for buckling mode shapes and bucking loads using the crack profile function of saw cut damage as described later herein.

According to certain embodiments, the concept of damage profile functions can be applied to multi-dimensional structures and multidimensional damage. For example, damage profile function defined for a sharp crack for a plate is given by:

$$γ ( {x}_{1} , {y}_{1} ) = [ H ( {x}_{1} - {x}_{1 d} ) - H ( {x}_{1} - {x}_{1 d} - Δ {l}_{1} ) ] [ H ( {y}_{1} - {y}_{1 d} ) - H ( {y}_{1} - {y}_{1 d} - Δ {l}_{2} ) ] = Δ A δ ( {x}_{1} - {x}_{1 d} ) δ ( {y}_{1} - {y}_{1 d} ) \qquad ( 12 )$$

where Δlᵢ gives the width of the damage in the i^{th} direction.

Multiple types of damage can be tackled using this methodology by summing the different crack profile functions for individual points of damage to represent a consolidated crack profile function.

$$γ ( {x}_{i} ) = {\sum }_{i = 1}^{i = N} {γ}_{i} ( {x}_{j} ) \qquad ( 13 )$$

Based on the above explanation, the stiffness and mass operator can be written as

$$L = {\sum }_{j = 0}^{r} {ε}^{j} {L}_{j} \\ m = {\sum }_{j = 0}^{q} {ε}^{j} {M}_{j} \qquad ( 14 )$$

### A. Perturbation

According to certain embodiments, the function φ(xᵢ) and λ are expanded using perturbation theory, with the superscripts denoting the order of perturbation, as the following series:

φ(xᵢ)=φ(xᵢ)⁰+∈φ(xᵢ)¹+∈²φ(xᵢ)²+ . . . λ=λ⁰+∈λ¹+∈²λ²+ . . . (15)

Substituting Equation 14 and Equation 15 into the governing differential Equation 1, the zeroth and n^{th} order equations (where n≧1) are given by

$$\begin{matrix}{ε}^{0} \text{:} {L}_{z 0} {φ}^{0} - {λ}_{z}^{0} {M}_{z 0} {φ}^{0} = 0 & ( 16 a ) \\ {ε}^{n} \text{:} {L}_{z 0} {φ}^{n} - {λ}_{2}^{0} {M}_{z 0} {φ}^{n} = {λ}_{2}^{n} {M}_{z 0} {φ}^{0} + {\sum }_{j = 1}^{min ( n ‖ q )} ( {λ}_{z}^{0} {M}_{z j} ) {φ}^{n - j} + {\sum }_{i = 1}^{n - 1} {λ}_{z}^{i} {M}_{z 0} {φ}^{n - 1} + {\sum }_{i = 1}^{n - 1} {\sum }_{j = 1}^{min ( i ‖ q )} {λ}_{z}^{i} {M}_{zj} {φ}^{n - i - j} - {\sum }_{j = 1}^{min ( n ‖ r )} {L}_{zj} {φ}^{n - j} & ( 16 b )\end{matrix}$$

For the Euler-column, the symbols L_{z0}, M_{z0}, M_{1z}, L_{z0}, L_{z1}, and λ_{z}ⁱ represent the following:

$${L}_{z 0} = \frac{{d}^{4}}{d {ζ}_{1}^{4}} \\ {M}_{z 0} = 1 \\ {L}_{z 1} = \frac{{d}^{2}}{d {ζ}_{1}^{2}} 3 {γ}_{z} ( {ζ}_{1} ) \frac{{d}^{2}}{d {ζ}_{1}^{2}} \\ {M}_{z 1} = 0 \\ {λ}_{z}^{i} = \frac{{PL}^{2}}{{EI}_{3}} \qquad ( 17 )$$

In the following example embodiment, the characteristics of the above development which will be used in the solution procedure include:
Through the process of perturbation and by using the damage model, the homogeneous differential equation with variable coefficients is changed to a series of non-homogeneous differential equations with constant coefficients.
The first differential equation of this series is the same as that representing the eigenvalue problem for the undamaged case.
The rest of the equation in the series of differential equations have the homogeneous part same as that of the first equation and therefore same as that for undamaged case.
The unknowns for the n^{th} order equation are the eigenfunctions φⁿ in the LHS of the equation and the eigenvalue λ_{z}ⁿ in the RHS of the equation.
The layout of the n^{th} order equation is given in a form so that the unknowns are given separately in individual terms, the second term in the RHS involving λ_{z}⁰ needs to be written separately to be able to write the unknown terms involving λ_{z}⁰ in the LHS. The third term in RHS involving M_{z0} is written separately to be able to use the orthogonality condition to simplify the final expression.

For the n^{th} order equation, the unknowns are φⁿ λ_{z}ⁿ. φn=φⁿ|_{complimentary}+φⁿ|_{particular}. The particular part of the solution can be expanded in terms of the modes of the undamaged structure using expansion theorem φₖⁿ|_{particular}=Σₚ₌₁^{∞}ηₖₚⁿφₚ⁰. This implies φⁿ|_{complimentary}=φ⁰.

In an example embodiment, the first order correction to buckling loads is given by:

$$\begin{matrix}{λ}_{{z}_{n}}^{1} = \frac{{α}_{{1}_{nn}} - {λ}_{{z}_{n}}^{0} {β}_{{1}_{nn}}}{{C}_{n}} \\ {η}_{nj}^{1} = \frac{{λ}_{zk}^{0} {β}_{{1}_{nj}} - {α}_{{1}_{nj}}}{( {λ}_{zj}^{0} - {λ}_{zn}^{0} ) {C}_{j}} \\ where & ( 18 ) \\ {\int }_{0}^{1} {( {φ}_{m}^{0} )}^{T} {M}_{zo} {φ}_{n}^{0} d {ζ}_{i} = {δ}_{mn} {C}_{m} = {δ}_{mn} {C}_{n} \\ {\int }_{0}^{1} {( {φ}_{m}^{0} )}^{T} {L}_{zo} {φ}_{n}^{0} d {ζ}_{i} = {δ}_{mn} {λ}_{m} {C}_{m} = {δ}_{mn} & ( 19 )\end{matrix}$$

where δₘₙ is the Kronecker delta. Notice the orthogonality condition does not hold for M_{zj} and L_{zj} where j≧1. For those cases, the following notations can be used to represent the equations compactly:

∫₀¹(φₘ⁰)^{T}L_{z1}φₙ⁰dxᵢ=α₁ₘₙ ∫₀¹(φₘ⁰)^{T}M_{z1}φₙ⁰dxᵢ=β₁ₘₙ (20)

Notice, as detailed in the solution procedure of undamaged plates, in the above equations m=rs and n=pq, where r, s, p, and q are integers. Computation of the energy equivalent inertia loss due to damage may be straight forward, however energy equivalent stiffness loss due to damage involves representation of Equation 20 using L_{z1} from Equation 17 and converting it into weak form to give:

$${α}_{{1}_{mn}} = {\int }_{0}^{{L}_{{z}_{i}}} {( {φ}_{{m}_{, {x}_{1} {x}_{1}}}^{0} )}^{T} 3 γ {φ}_{{n}_{, {z}_{1} {z}_{1}}} + {v ( {φ}_{{m}_{, {x}_{1} {x}_{1}}}^{0} )}^{T} 3 γ {φ}_{{n}_{, {z}_{2} {z}_{2}}} + 2 ( 1 - v ) {( {φ}_{{m}_{, {x}_{1} {x}_{2}}}^{0} )}^{T} 3 γ {{φ}_{{n}_{,}} ( {φ}_{{m}_{, {z}_{2} {z}_{2 }}}^{0} )}^{T} 3 γ {φ}_{{n}_{, {x}_{2} {x}_{2}}} + {v ( {φ}_{{m}_{, {x}_{2} {z}_{2}}}^{0} )}^{T} 3 γ {φ}_{{n}_{, {x}_{1} {x}_{1}}} d {x}_{i} {β}_{{1}_{mn}} = {\int }_{0}^{1} {( {φ}_{m}^{0} )}^{T} γ {φ}_{n}^{0} d {ζ}_{i} \qquad ( 21 )$$

### B. Solution for Arbitrary Damage Profile

According to certain embodiments, to determine the buckling mode shapes and buckling loads for an arbitrary damage profile, the modes shapes and natural frequencies are determined using a sharp damage modeled using a delta function γ_{z}(ζᵢ)=δ(ζᵢ−ζ_{di}). Let the eigenfunction (buckling mode shape) and the eigenvalue (which can be used to determine the buckling loads) be determined using such a damage profile be φ_{δ}_{ₖ}(ζᵢ) and λ_{δ}_{ₖ}(ζᵢ) respectively. A convolution integral in space domain is used to determine buckling mode shapes and buckling loads for any arbitrary damage profile. The final expressions is given by:

φₖ(ζᵢ)=∫_{Ω}φ_{δ}_{ₖ}(ζᵢ−ζ_{d}_{ᵢ})γ(ζ_{d}_{ᵢ})dζ_{d}_{ᵢ} (22)

λₖ=∫_{Ω}λ_{δ}_{ₖ}γ(ζ_{d}_{_{ε}})dζ_{d}_{_{ε}}

where ζ_{d} is the spatial location of the damage. For multiple damage locations, the damage profile function for multiple areas of damage given by Equation 13 is used:

$${φ}_{k} ( {ζ}_{i} ) = {\sum }_{j = 1}^{p} {\int }_{{Ω}_{j}} {φ}_{{δ}_{k}} ( {ζ}_{i} - {ζ}_{{d}_{i}} ) γ ( {ζ}_{{d}_{i}} ) d {ζ}_{{d}_{i}} \\ {λ}_{k} = {\sum }_{j = 1}^{p} {\int }_{{Ω}_{j}} {λ}_{{δ}_{k}} γ ( {ζ}_{{d}_{i}} ) d {ζ}_{{d}_{i}} \qquad ( 23 )$$

The subscript j denotes the damage number iterator and number and p denotes the total number of independent damage locations. Although, the buckling load does not depend on the spatial variable ζi, it still can be determined in the same way.

To verify the correctness of the expression, the first-order correction is compared against the ones derived for Euler-Bernoulli beams and for Timoshenko beams. They were found to be the same.

$${λ}_{{z}_{n}}^{1} = \frac{{α}_{nn} - {λ}_{{z}_{n}}^{0} {β}_{nn}}{{μ}_{nn}} \\ {η}_{nj}^{1} = \frac{{λ}_{{z}_{k}}^{0} {β}_{nj} - {α}_{nj}}{( {λ}_{{z}_{j}}^{0} - {λ}_{{z}_{n}}^{0} ) {μ}_{jj}} \qquad ( 24 )$$

The second-order correction quantities are obtained as solution to Equation 16b:

$$\begin{matrix} {λ}_{{z}_{n}}^{2} = \frac{{α}_{{1}_{nn}} - {λ}_{{z}_{n}}^{1} {β}_{{1}_{nn}} - {λ}_{{z}_{n}}^{0} {β}_{{1}_{nn}}}{{C}_{n}} & ( 25 ) \\ {η}_{nj}^{2} = \frac{{λ}_{{z}_{n}}^{1} {β}_{{1}_{nj}} + {λ}_{{z}_{n}}^{1} {η}_{nj}^{1} {C}_{j} {λ}_{{z}_{n}}^{0} {β}_{{1}_{nj}} + {λ}_{{z}_{n}}^{0} {\sum }_{l = 1 , l \neq n}^{∞} {η}_{nj}^{1} {β}_{{1}_{nj}} - {α}_{{1}_{nj}} - {\sum }_{l = 1 , l \neq n}^{∞} {η}_{nj}^{1} {α}_{1}}{{C}_{j} ( {λ}_{{z}_{j}}^{0} - {λ}_{{z}_{n}}^{0} )} & ( 26 )\end{matrix}$$

### Results and Verification

The ability of this application to correctly predict the buckling load results for damaged columns using Euler-column theory was ascertained. A finite element model of the beam was constructed using ABAQUS with both simply-supported and clamped-free end conditions. For the rectangular column, the constants involved were E=12 kN/mm², L=6000 mm, I=10⁸ mm⁴, x_{d}=0.3L, k=6, ΔL_{z}=0.005, ∈=0.2h. The column was modeled with three-dimensional brick elements with a mesh seed size 30 mm.

The results for the simply-supported end condition are presented in Table 1 and those for clamped-free end condition in Table 2.

TABLE 1
Buckling load comparison (N): Simply supported beam E = 12 kN/mm², L = 6000 mm,
h = 200 mm, b = 150 mm, x_{d} = 0.3 L, ΔL = 0.005 L, ε = 0.2 h.

| | FE-Model | | Analytical | | % Difference | |
|---|---|---|---|---|---|---|
| Mode | U | D | U | D | $\frac{{C}_{3} - {C}_{1}}{{C}_{3}} \times 100$ | $\frac{{C}_{2} - {C}_{4}}{{C}_{2}} \times 100$ |
| 1 | 0.184871 | 0.183616 | 0.185055 | 0.180695 | 0.10 | 1.6 |
| 2 | 0.328391 | 0.321036 | 0.328987 | 0.321235 | 0.18 | −0.06 |
| 3 | 0.737279 | 0.730476 | 0.740220 | 0.716117 | 0.33 | 1.97 |
| 4 | 1.30648 | 1.26735 | 1.31595 | 1.27310 | 0.72 | −0.45 |
| 5 | 1.65069 | 1.64880 | 1.66550 | 1.65977 | 0.89 | −0.67 |
| 6 | 2.91346 | 2.90363 | 2.96088 | 2.92405 | 1.60 | −0.70 |
| 7 | 2.91447 | 2.90398 | 2.96088 | 2.95070 | 1.57 | −1.61 |
| 8 | 4.51425 | 4.47034 | 4.62638 | 4.45983 | 2.42 | 0.23 |
| 9 | 5.11613 | 5.05407 | 5.26379 | 5.19832 | 2.81 | −2.85 |

D—Damaged,
U—Undamaged,
critical load is given in ×10⁶,
C# denotes the table-column number.

TABLE 2
Buckling load comparison (N): Clamped free beam E = 12 kN/mm², L = 6000 mm,
h = 200 mm, b = 150 mm, x_{d} = 0.3 L, ΔL = 0.005 L, ε = 0.2 h.

| | FE-Model | | Analytical | | % Difference | |
|---|---|---|---|---|---|---|
| Mode | U | D | U | D | $\frac{{C}_{3} - {C}_{1}}{{C}_{3}} \times 100$ | $\frac{{C}_{2} - {C}_{4}}{{C}_{2}} \times 100$ |
| 1 | 0.046324 | 0.045944 | 0.046263 | 0.044941 | −0.13 | 2.18 |
| 2 | 0.082319 | 0.080117 | 0.082246 | 0.079896 | −0.01 | 0.28 |
| 3 | 0.416086 | 0.415956 | 0.416374 | 0.416007 | 0.01 | 0.00 |
| 4 | 0.738182 | 0.737533 | 0.740220 | 0.739568 | 0.27 | −0.28 |
| 5 | 1.15119 | 1.14524 | 1.15659 | 1.13578 | 0.46 | 0.83 |
| 6 | 2.03578 | 2.00066 | 2.05617 | 2.01916 | 0.99 | −0.92 |
| 7 | 2.24298 | 2.22105 | 2.26692 | 2.18731 | 1.06 | 1.52 |
| 8 | 3.67880 | 3.66988 | 3.74737 | 3.71956 | 1.83 | −1.35 |
| 9 | 3.94775 | 3.82157 | 4.03009 | 3.88856 | 2.04 | −1.75 |

D—Damaged,
U—Undamaged,
critical load is given in ×10⁶,
C# denotes the table-column number.

The two end conditions collectively simulate the symmetric and asymmetric cases. It should be noted that the baseline for calculation of percentage difference for the undamaged case was the analytical results, whereas for damaged case it was the finite element results. This was done because for the undamaged case, the theoretical values predicted using the Euler-column theory are considered better than those predicted by finite-element models. However, in the case of the damaged columns, the unified framework presented is a relatively new theory and the objective to correlate the results obtained by the finite-element model (already validated for the undamaged case using Euler-column theory) to the those obtained by unified framework.

### Conclusions

It was successfully demonstrated that an application the unified framework previously used to determine natural frequencies and modes of a damaged beam can be modified to also predict the buckling loads and buckling modes of a damaged Euler-column.

The average of the absolute values of the percentage difference between those calculated by using finite element model and those by using Euler-column theory of the simply supported case for the undamaged columns was 1.18%. The average of the absolute values of the percentage difference between those calculated theoretically by using unified theory and those by using the finite-element model of the simply supported case for the damaged columns was 1.12%. The same two values for the clamped-free case are 0.76% and 1.01%, respectively.

Based on the above information the following conclusions can be made: (1) The unified framework can predict results to a good level of accuracy with reference to the finite element results. (2) It may also be inferred that the unified framework does not always give conservative values of the buckling loads. However, this inference would have to be based on the assumption that the values predicted by the finite element models are accurate. This assumption is incorrect; and, therefore, it is difficult to say whether the unified framework gives conservative values of the buckling loads.

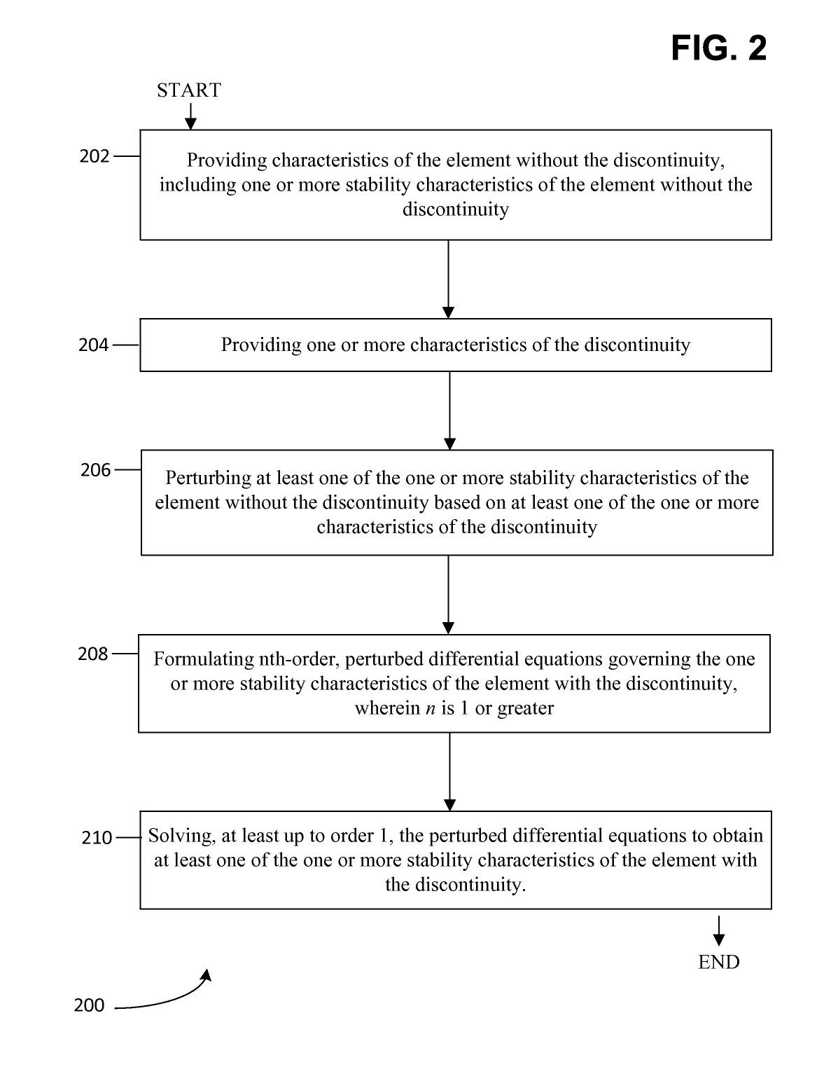

FIG. 2 is a flow diagram of the method 200 As shown in FIG. 2, the method 200 starts in block 202, and according to an example embodiment includes providing characteristics of the element without the discontinuity, including one or more stability characteristics of the element without the discontinuity. In block 204, the method 200 includes providing one or more characteristics of the discontinuity. In block 206, the method 200 includes perturbing at least one of the one or more stability characteristics of the element without the discontinuity based on at least one of the one or more characteristics of the discontinuity. In block 208, the method 200 includes formulating nth-order, perturbed differential equations governing the one or more stability characteristics of the element with the discontinuity, wherein n is 1 or greater. In block 210, the method 200 includes, solving, at least to order 1, the perturbed differential equations to obtain at least one of the one or more stability characteristics of the element with the discontinuity.

It will be understood that the various steps shown in FIG. 2 are illustrative only, and that steps may be removed, other steps may be used, or the order of steps may be modified.

Embodiments of the disclosed technology can be utilized in an a computing environment and computer systems thereof. The computing environment and computer systems represent only one example of a suitable computing environment and computer systems for the practice of the disclosed technology and are not intended to suggest any limitation as to the scope of use or functionality of the disclosed technology. Nor should the computer systems be interpreted as having any dependency or requirement relating to any one or combination of components disclosed hereinafter.

Hence, it should be understood that the disclosed technology is operational with numerous other general purpose or special purpose computing system environments or configurations. Examples of well-known communication devices, computing systems, environments, and/or configurations that may be appropriate or suitable for use with the disclosed technology include, but are not limited to, personal computers, server computers, hand-held or laptop devices, multiprocessor systems, microprocessor-based systems, set top boxes, programmable consumer electronics, network personal computers, minicomputers, mainframe computers, distributed computing environments that include any of the above systems or devices, and the like.

The disclosed technology may also be described in the general context of comprising computer-executable instructions, such as program modules, being executed by a computer system. Generally, program modules include routines, programs, programming, objects, components, data, and/or data structures that perform particular tasks or implement particular abstract data types. The disclosed technology may be practiced in distributed computing environments where tasks are performed by remote processing devices that are linked through a communications network. In a distributed computing environment, program modules may be located in both local and remote computer storage media, including, without limitation, in memory storage devices.

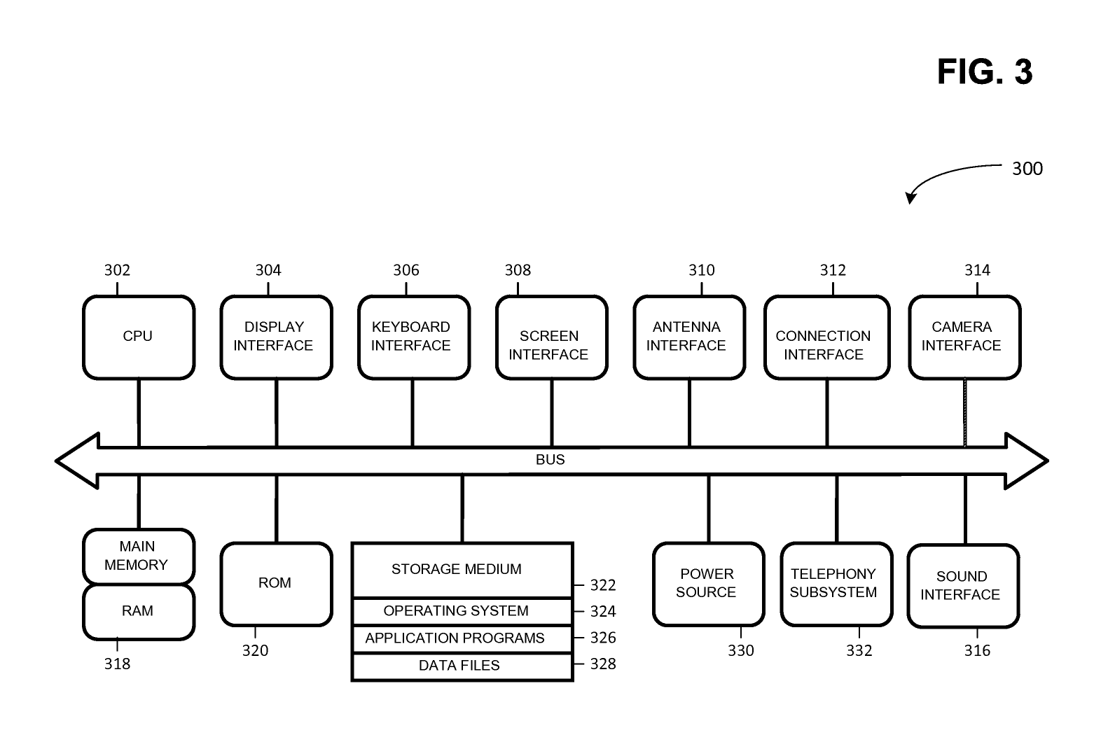

FIG. 3 depicts a block diagram of an illustrative computing device architecture 300, according to an example embodiment. Various embodiments and methods herein may be embodied in non-transitory computer readable media for execution by a processor. It will be understood that the architecture 300 is provided for example purposes only and does not limit the scope of the various embodiments of the disclosed systems and methods.

The architecture 300 of FIG. 3 includes a central processing unit (CPU) 302, where computer instructions are processed; a display interface 304 that acts as a communication interface and provides functions for rendering video, graphics, images, and texts on coupled displays; a keyboard interface 306 that provides a communication interface to a keyboard; and a pointing device interface 308 that provides a communication interface to a pointing device, e.g., a touchscreen or presence-sensitive screen. Example embodiments of the architecture 300 may include an antenna interface 310 that provides a communication interface to an antenna. Example embodiments may include a connection interface 312. The connection interface may include one or more of a peripheral connection interface and network communication interface, providing a communication interface to an external device or network. In certain embodiments, a camera interface 314 may be provided that acts as a communication interface and provides functions for capturing digital images from a camera. In certain embodiments, a sound interface 316 may be provided as a communication interface for converting sound into electrical signals using a microphone and for converting electrical signals into sound using a speaker. According to example embodiments, a random access memory (RAM) 318 may be provided, where computer instructions and data may be stored in a volatile memory device for processing by the CPU 302.

According to an example embodiment, the architecture 300 may include a read-only memory (ROM) 320 where invariant low-level system code or data for basic system functions such as basic input and output (I/O), startup, or reception of keystrokes from a keyboard are stored in a non-volatile memory device. According to an example embodiment, the architecture 300 may include a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an example embodiment, the architecture 300 may include a power source 330 that provides an appropriate alternating current (AC) or direct current (DC) to power components. According to an example embodiment, the architecture 300 may include a telephony subsystem 332 that allows the device 300 to transmit and receive sound over a telephone network. The constituent devices and the CPU 302 may communicate with each other over a bus 334.

In accordance with an example embodiment, the CPU 302 may have appropriate structure to be a computer processor. In one arrangement, the computer CPU 302 may include more than one processing unit. The RAM 318 may interface with the computer bus 334 to provide quick RAM storage to the CPU 302 during the execution of computing programs such as the operating system application programs, and device drivers. More specifically, the CPU 302 may load computer-executable process steps from the storage medium 322 or other media into a field of the RAM 318 in order to execute computing programs. Data may be stored in the RAM 318, where the data may be accessed by the computer CPU 302 during execution. In one example configuration, the device 300 may include at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media may allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

In an example embodiment of the disclosed technology, the mobile computing device computing system architecture 300 may include any number of hardware and/or software applications that are executed to facilitate any of the operations. In an example embodiment, one or more I/O interfaces may facilitate communication between the mobile device computing system architecture 300 and one or more input/output devices. For example, a universal serial bus port, a serial port, a disk drive, a CD-ROM drive, and/or one or more user interface devices, such as a display, keyboard, keypad, mouse, control panel, touchscreen display, microphone, etc., may facilitate user interaction with the mobile device computing system architecture 300. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the mobile device computing system architecture 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, a proximity network, etc., for communication with external devices and/or systems. As desired, embodiments of the disclosed technology may include the mobile device computing system architecture 300 with more or less of the components illustrated in FIG. 3.

Certain embodiments of the disclosed technology are described above with reference to block and flow diagrams of systems and methods and/or computer program products according to example embodiments of the disclosed technology. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method of modeling an element with a discontinuity to obtain stability characteristics of the element with the discontinuity, the method comprising:
providing characteristics of the element without the discontinuity, including one or more stability characteristics of the element without the discontinuity;
providing one or more characteristics of the discontinuity;
perturbing at least one of the one or more stability characteristics of the element without the discontinuity based on at least one of the one or more characteristics of the discontinuity;
formulating nth-order, perturbed differential equations governing the one or more stability characteristics of the element with the discontinuity, wherein n is 1 or greater; and
solving, at least up to order 1, the perturbed differential equations to obtain at least one of the one or more stability characteristics of the element with the discontinuity.

2. The method of claim 1, wherein the obtained stability characteristics of the element with the discontinuity comprise one or more of buckling mode shapes and buckling loads.

3. The method of claim 1, wherein the element comprises a physical structure.

4. The method of claim 1, wherein the discontinuity comprises damage to the element.

5. The method of claim 1, wherein the element comprises more than one discontinuity.

6. The method of claim 1, wherein the one or more characteristics of the discontinuity comprise a geometric definition of the discontinuity.

7. The method of claim 1, wherein one or more stability characteristics of the element with the discontinuity are determined by using a convolution integral in space domain over the domain of the discontinuity.

8. A system for modeling an element with a discontinuity to obtain one or more stability characteristics of the element with the discontinuity, the system comprising:
a first storage unit adapted to store one or more characteristics of the element without the discontinuity, including one or more stability characteristics of the element without the discontinuity;
a second storage unit adapted to store one or more characteristics of the discontinuity;
a third storage unit adapted to store data related to perturbing the one or more stability characteristics of the element without the discontinuity based on the one or more characteristics of the discontinuity;
a first processor adapted to formulate nth-order, perturbed differential equations governing the one or more stability characteristics of the element with the discontinuity, wherein n is 1 or greater; and
a second processor adapted to solve, at least up to order 1, the perturbed differential equations to obtain the one or more stability characteristics of the element with the discontinuity.

9. The system of claim 8, wherein the obtained stability characteristics of the element with the discontinuity comprise one or more of buckling mode shapes and buckling loads.

10. The system of claim 8, wherein the element comprises a physical structure.

11. The system of claim 8, wherein the discontinuity comprises damage to the element.

12. The system of claim 8, wherein the element comprises more than one discontinuity.

13. The system of claim 8, wherein the one or more characteristics of the discontinuity comprise a geometric definition of the discontinuity.

14. The system of claim 8, wherein one or more stability characteristics of the element with the discontinuity are determined by using a convolution integral in space domain over the domain of the discontinuity.

15. A computer program product comprising a non-transitory computer-readable medium that stores instructions executable by one or more processors to perform a method of modeling a physical structure with damage to obtain one or more stability characteristics of the physical structure with the damage, the method comprising:
providing characteristics of the physical structure without the damage, including one or more stability characteristics of the physical structure without the damage;
providing one or more characteristics of the damage;
perturbing the one or more stability characteristics of the physical structure without the damage based on the one or more characteristics of the damage;
formulating nth-order, perturbed differential equations governing the one or more stability characteristics of the physical structure with the damage, wherein n is 1 or greater; and
solving, at least up to order 1, the perturbed differential equations to obtain the one or more stability characteristics of the physical structure with the damage.

16. The computer program product of claim 15, wherein the obtained stability characteristics of the element with the discontinuity comprise one or more of buckling mode shapes and buckling loads.

17. The computer program product of claim 15, wherein the damage comprises one or more cracks in the physical structure.

18. The computer program product of claim 15, wherein the damage comprises one or more notches in the physical structure.

19. The computer program product of claim 15, wherein the physical structure comprises a column.

20. The computer program product of claim 15, wherein one or more stability characteristics of the element with the damage are determined by using a convolution integral in space domain over the domain of the damage.
